(19) United States
(12) Patent Application Publication
(10) Pub. No.: US 2016/0036479 A1
(43) Pub. Date: Feb. 4, 2016

(54) CELL PHONE PROTECTION CASE STRUCTURE HAVING SUPPORT FRAME

(71) Applicant: JOE LIN, TAICHUNG CITY (TW)

(72) Inventor: JOE LIN, TAICHUNG CITY (TW)

(21) Appl. No.: 14/447,774

(22) Filed: Jul. 31, 2014

(51) Int. Cl. H04B 1/3888; H04M 1/04

(52) U.S. Cl. CPC H04B 1/3888; H04M 1/04

(57) ABSTRACT

The present invention relates to a cell phone protection case structure having a support frame. The protection case has a structure to support a cell phone at an angle. The protection case pairs of cut lines and folding lines in a predetermined shape to form a support piece and a retaining piece to engage with each other. Wherein, the support piece and the retaining piece can be folded to be flush with the call phone or unfolded at an angle so that the protection case can be placed at an angle to support the cell phone at an angle for the user to use the cell phone conveniently.

### BACKGROUND OF THE INVENTION

1. Field of the Invention

The present invention relates to a cell phone protection case structure having a support frame, and more particularly to a cell phone protection case having an integral support structure for a cell phone to be held at an angle so that the user can use the cell phone conveniently.

2. Description of the Prior Art

There are many cell phone protection cases on the market. They only provide a function to protect the cell phone. The cell phone can be placed at an angle. When the cell phone is placed on the tabletop, it is inconvenient to use the cell phone. It is necessary to provide a cell phone bracket for the cell phone to be placed on the tabletop at an angle. However, the cell phone bracket is expensive, inconvenient to take along, and large in size. Accordingly, the inventor of the present invention has devoted himself based on his many years of practical experiences to solve these problems.

### SUMMARY OF THE INVENTION

The primary object of the present invention is to improve the conventional cell phone protection case. The present invention relates to a cell phone protection case structure having a support frame. The protection case has a support piece and a retaining piece which can be folded. Wherein, the support piece and the retaining piece can be folded to be flush with a cell phone for the user to take along conveniently. The support piece and the retaining piece can be unfolded at an angle to support the cell phone at an angle for the user to use the cell phone conveniently.

### BRIEF DESCRIPTION OF THE DRAWINGS

FIG. 1 is a perspective view of the present invention in a folded state;

FIG. 2 is a perspective view of the present invention in an unfolded state;

FIG. 3 is a cross-sectional view of the present invention in a use state;

FIG. 4 is a perspective view of another embodiment of the present invention in a folded state; and

FIG. 5 is a perspective view of FIG. 4 in an unfolded state.

### DETAILED DESCRIPTION OF THE PREFERRED EMBODIMENTS

Embodiments of the present invention will now be described, by way of example only, with reference to the accompanying drawings.

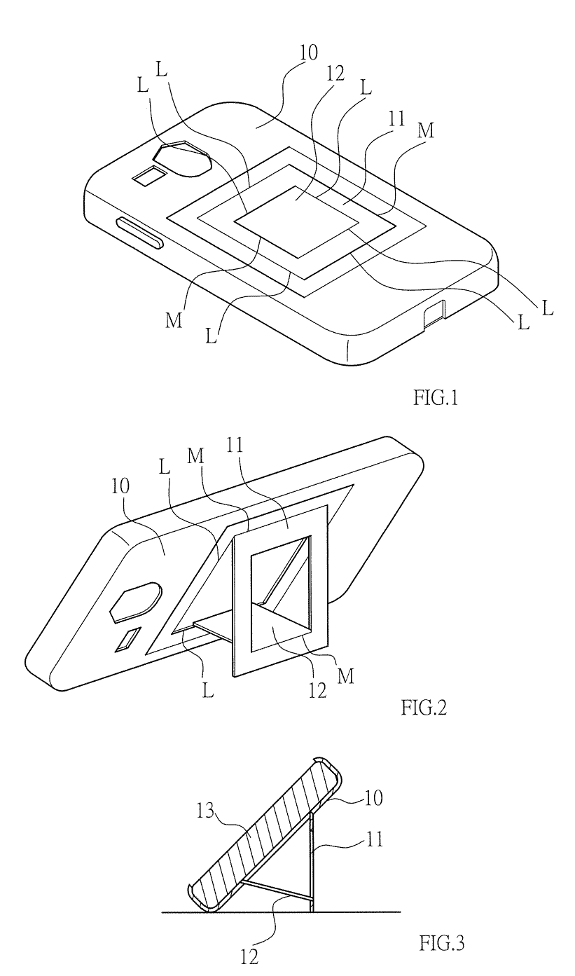

As shown in FIG. 1, FIG, 2, and FIG. 3, a cell phone protection case 10 has two pairs of cut lines L and folding lines M in a predetermined shape, such as a reverse U shape, to form a support piece 11 and a retaining piece 12. The use, effect, and details of the present invention are described hereinafter.

1. In a folded state: As shown in FIG. 1, the support piece 11 and the retaining piece 12 are folded to be flush with a cell phone 13, namely, the support piece 11, the retaining piece 12 and the cell phone 13 are on the same level. The protection case 10 won't occupy space and can be carried conveniently.

2. In an unfolded state: As shown in FIG. 2 and FIG. 3, through the cut lines L and the folding lines M of the support piece 11 and the retaining piece 12, the support piece 11 and the retaining piece 12 are unfolded to be three-dimensional, One end of the retaining piece 12 is against the cell phone 13, such that the cell phone 13 can be supported at an angle on the tabletop for the user to user the cell phone conveniently.

The embodiments and configurations of the present invention are as follows:

1. The retaining piece 12 and the support piece 11 can be integrally formed with the protection case 10 by injection molding, or the retaining piece 12 and the support piece 11 are separate members which can be coupled to the protection case 10.

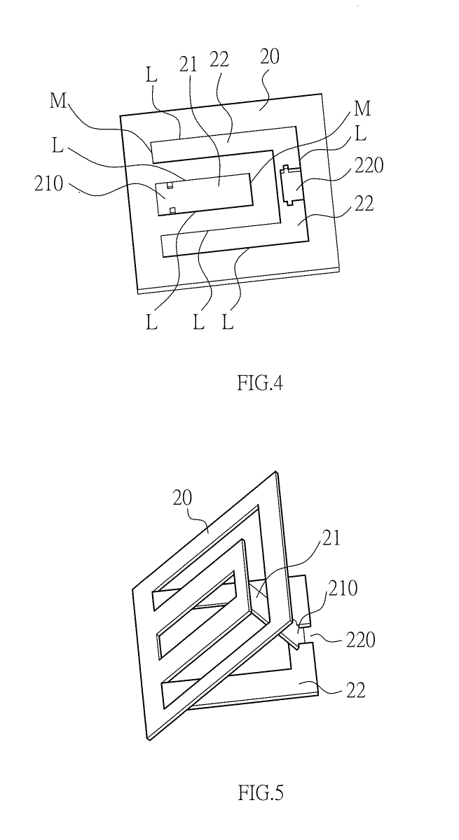

2. As shown in FIG. 4 and FIG. 5, a plate 20 has two pairs of cut lines L and folding lines M in a predetermined shape to form a support piece 21 and a retaining piece 22. The retaining piece 22 has an engaging trough 220. The support piece 21 has an engaging piece 210. The engaging piece 210 can be engaged in the engaging trough 220 to position the retaining piece 22 and the support piece 21.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A cell phone protection case structure having a support frame, comprising a protection case, the protection case having two pairs of cut lines and folding lines in a predetermined shape to form a support piece and a retaining piece, wherein the support piece and the retaining piece can be folded repeatedly, enabling the support piece and the retaining piece to be flush with a cell phone, or the support piece and the retaining piece can be unfolded to stand at an angle se as to support the cell phone.

2. The cell phone protection case structure having a support frame as claimed in claim 1, wherein the support piece and the retaining piece are integrally formed with the protection case by injection molding.

3. The cell phone protection case structure having a support frame as claimed in claim 1, wherein the support piece and the retaining piece are separate members coupled to the protection case.

4. The cell phone protection case structure having a support frame as claimed in claim 1, wherein the retaining piece has an engaging trough and the support piece has an engaging piece, wherein the engaging piece can be engaged in the engaging trough.
